(19) United States
(12) Patent Application Publication
(10) Pub. No.: US 2004/0061794 A1
(43) Pub. Date: Apr. 1, 2004

(54) Editing facility for digital video

(75) Inventor: William Kress Bodin, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, Armonk, NY

(21) Appl. No.: 10/256,103

(22) Filed: Sep. 26, 2002

(51) Int. Cl. H04N 5/76

(52) U.S. Cl. 348/231.99

(57) ABSTRACT

Creating and playing an edited version of a digital video tape including designating, through controls on a digital video camcorder, at least one included segment of the digital video tape; storing in memory an initial portion of the included segment, wherein the memory comprises non-volatile, non-sequential computer memory installed within a digital video camcorder; playing the initial portion from the memory to a display; synchronizing the initial portion and the included segment; and playing the included segment to the display.

### BACKGROUND OF THE INVENTION

1. Field of the Invention

The field of the invention is methods and systems for playing an edited version of a digital videotape.

2. Description of Related Art

Prior art digital video camcorders cannot edit video. To edit their video tapes, users of digital video camcorders must remove the tape from the camcorder, install the tape in an editing facility, such as a personal computer equipped with editing software, edit the tape, and return an edited version of the tape for display. Alternatively, users can connect their camcorders to an editing facility through a so-called universal serial bus or “USB” for editing with the tape still in the camcorder, although the overall result is the same: a laborious external process. It would be advantageous if there were simple editing tools for use on the camcorder itself.

### SUMMARY OF THE INVENTION

Camcorders according to the present invention include methods for playing an edited version of a digital video tape including designating, through controls on a digital video camcorder, at least one included segment of the digital video tape; storing in memory an initial portion of the included segment, wherein the memory comprises non-volatile, non-sequential computer memory installed within a digital video camcorder; playing the initial portion from the memory to a display; synchronizing the initial portion and the included segment; and playing the included segment to the display. Embodiments also include repeating for a multiplicity of included segments the steps of playing the initial portion from the memory to a display; synchronizing the initial portion and the included segment; and playing the included segment to the display. Embodiments also include striping the digital video tape.

In many embodiments, storing in memory an initial portion of the included segment comprises creating an included segment record in memory. In many embodiments, creating an included segment record in memory comprises recording, in an included segment record, a beginning time code for the included segment and recording an ending time code for the included segment. In typical embodiments, storing an initial portion of the included segment comprises recording the initial portion in an included segment record. In most embodiments, storing an initial portion of the included segment comprises storing the initial portion in memory and storing a filename in an included segment record.

In typical embodiments, the initial portion of the included segment is of sufficient length to support synchronizing the initial portion and the included segment. Typical embodiments include determining the length of the initial portion. In such embodiments, synchronizing playback includes tracking a current time code from the initial portion; and moving the included segment to the tracked current time code.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a line drawing of an example digital video camcorder.

FIG. 2 is a block diagram of an example digital video camcorder.

FIG. 3 is a data flow diagram showing aspects of playing an edited version of a digital video tape.

FIG. 4 is a data flow diagram showing aspects of striping a digital video tape.

FIG. 5 is a table showing the data structure of the SMPTE time code.

FIG. 6 is a data flow diagram showing aspects of storing an initial portion in non-volatile, non-sequential computer memory and creating an included segment record.

FIG. 7 is a data flow diagram showing aspects of synchronizing an included segment played from digital video tape with an initial portion played from non-volatile, non-sequential computer memory.

### DETAILED DESCRIPTION OF EXEMPLARY EMBODIMENTS

Introduction

The present invention is described to a large extent in this specification in terms of methods for playing an edited version of a digital videotape. Persons skilled in the art, however, will recognize that any system that includes suitable means for operating a digital video camcorder in accordance with the disclosed methods also falls well within the scope of the present invention.

Suitable means for operating a digital video camcorder include any means for directing a digital video camcorder to execute the steps of the method of the invention, including for example, systems comprised of processing units and arithmetic-logic circuits coupled to computer memory, which systems have the capability of storing in computer memory, which computer memory includes electronic circuits configured to store data and program instructions, and programmed steps of the method of the invention for execution by a processing unit.

Definitions

“Digital video” means any video signal, video data, or video content recorded in digital format including video with or without audio accompaniment. Digital video is often recorded with a digital video camcorder.

“Digital video tape” means magnetic recording tape on which digital video is recorded. Magnetic recording tape often comprises layers of evaporated metal. Such metal layers typically are covered by a hard layer of carbon that protects them. Magnetic recording tape typically has a back coating that reduces friction and provides smooth tape movement. Digital video tape is often available in a cassette.

“Digital video camcorder” (or “camcorder”) means any device that includes both a digital video camera and a digital video recorder so that digital video output from the digital video camera can be recorded directly within the device. Digital video camcorders typically record on digital video tape, although digital video camcorders can support other media including, for example, optical disks and magnetic disks such as floppy disks.

“MIDI” means Musical Instrument Digital Interface. MIDI is a standard adopted by the electronic music industry for controlling devices that emit music. MIDI representations of sounds include values for a note's pitch, length, and volume. A MIDI representation of sound can also include a note's attack and delay time.

“Playback” means playing a recorded digital video. In this disclosure “play” and “playback” are synonyms.

“Striping” means adding time codes to a digital video recording.

“SMPTE time code” means a standard time code promulgated by the Society of Motion Picture and Television Engineers. When a digital video is striped with SMPTE time codes, a SMPTE time code is assigned to every frame of the video. The SMPTE time code represents hours, minutes, seconds, frames, and some additional user-specified information such as tape number and date. For example, the time code number 01:12:59:16 represents a picture 1 hour, 12 minutes, 59 seconds, and 16 frames into the recording.

A “sync word” is a synchronization signal encoded in a time code and therefore in a time code track or stripe. A digital video camcorder reads sync words to determine speed or frame rate of video playback from a digital video tape or other medium.

“Time code” means a code that identifies a video frame within a digital video recording. Time codes are formatted to fit into digital video data structures. Some time codes are proprietary. Some time code formats are non-proprietary standards, as, for example, SMPTE time codes and MIDI time codes. There is no limitation of the present invention to any particular time code or time code format. The use of any time codes that will occur to those of skill in the art are well within the scope of the present invention.

### DETAILED DESCRIPTION

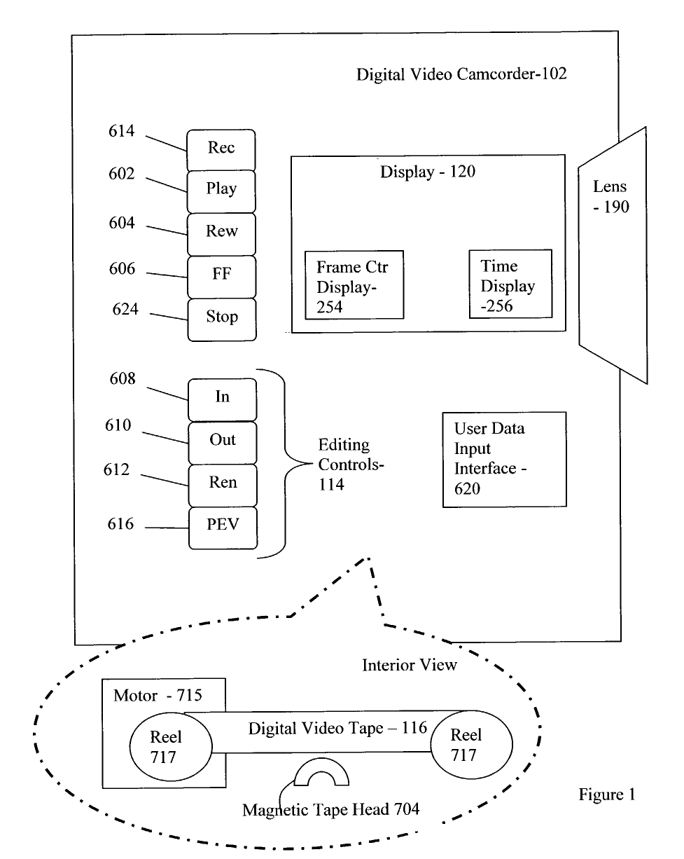

FIG. 1 is a line drawing of a digital video camcorder (102) useful according to various exemplary embodiments of the present invention. FIG. 1 is generally a view of the exterior of the digital video camcorder, but has a single interior view surrounded by dashed lines to illustrate interior parts of the digital video camcorder (102).

The digital video camcorder (102) of FIG. 1 has a record (614) control. When a user presses the record control (614), the digital video camcorder (102) records a digital video onto a digital video tape (116). Internal electronics write the digital video on the digital video tape through the magnetic tape head (704).

The digital video camcorder (102) of FIG. 1 has a play control (602). When the user presses the play control (602), the digital video camcorder (102) is instructed to play the digital video recorded onto the digital video tape (116) to a display (120). To play digital video to the display (120), the digital video camcorder (102) moves the digital video tape (116) across a magnetic tape head (704). To move the digital video tape (116) the digital video camcorder (102) has a motor (715) that turns at least one of two capstans inserted into reels (717). The reels (717) are connected to either end of a digital video tape (116). The digital video tape is wound around the reels (717). Turning the reel (717) places tension on the digital video tape (116) and pulls the digital video tape causing (116) the digital video tape (116) to wind around the motor driven turning reel (717). The other reel (717) rotates freely to reduce the tension on the digital video tape (116) and allows the digital video tape (116) to wind around the motor driven turning reel (717). The digital video camcorder (102) uses internal electronics to read from the digital video tape (116) and play the digital video to the display (120).

The digital video camcorder (102) of FIG. 1 has a rewind control (604). When a user presses the rewind control (604), the digital video camcorder (102) rewinds the digital video tape (116) by turning at least one of two capstans inserted into the reels (717) with the motor (715). Again, turning the reel (717) places tension on the digital video tape (116) and pulls the digital video tape (116) causing the digital video tape (116) to wind around the motor driven turning reel (717). The other reel (717) rotates freely to reduce the tension on the digital video tape (116) and allow the digital video tape (116) to wind around the motor driven turning reel (717). When the digital video camcorder (102) rewinds the digital video tape (116), the motor (715) turns the reels (717) faster than the motor (715) turns the reels (717) when playing a digital video. The motor (715) turns the reels (717) in opposite directions when the digital video camcorder (102) rewinds and when the digital video camcorder (102) plays.

The digital video camcorder (102) of FIG. 1 has a fast-forward (606) control. When a user presses the fast-forward control (606), the digital video camcorder (102) fast-forwards the digital video tape (116) by turning at least one of two capstans inserted into the reels with the motor (715). Again, turning the reel (717) places tension on the digital video tape (116) and pulls the digital video tape (116) causing the digital video tape (116) to wind around the motor driven turning reel (717). The other reel (717) rotates freely to reduce the tension on the digital video tape (616) and allow the digital video tape (616) to wind around the motor driven turning reel (717). When the digital video camcorder (102) fast-forwards the digital video tape (116), the motor (715) turns the reels (717) faster than the motor (715) turns the reels (717) when playing a digital video. The motor (715) turns the reels (717) in the same direction when the digital video camcorder (102) fast-forwards and when the digital video camcorder (102) plays.

For convenience and clarity of explanation, FIG. 1 illustrates the motor (715) as connected to only one reel (717). In actual operation, the motor (715) drives both reels (717). The operations of playing and fast-forwarding wind the digital video tape (116) in a direction such that the magnetic tape head (704) is increasingly closer to the end of digital video tape (116). The operation of rewinding moves the digital video tape (116) such that the magnetic tape head (704) is increasingly closer to the beginning of the digital video tape (116).

The digital video camcorder (102) of FIG. 1 has editing controls (114). The editing controls (114) include an “In” control (608), an “Out” control, a “Render” control (612), and a “Play edited version” control (616). The user presses the “In” control (608) to designate the beginning of an included segment of the digital video tape (116) and the “Out” control to designate the end of an included segment. When the user operates the “In” control, typically by pressing a button on the case of the camcorder, then the camcorder is programmed to store in non-volatile, non-sequential computer memory a time code identifying the beginning of an include segment.

An included segment is a subset of the total digital video tape (116). The included segment is a segment of the digital video recorded on the digital video tape the user wishes to be played in an edited version. The user may designate a multiplicity of included segments to be played in an edited version of the video tape by pressing the “In” control (608) to designate the beginning of the included segment and the “Out” control to designate the end of the included segment. When the user operates the “Out” control, typically by pressing a button on the case of the camcorder, then the camcorder is programmed to store in non-volatile, non-sequential computer memory a time code identifying the end of an include segment.

The user presses the “Render” control (612) of FIG. 1 to instruct the digital video camcorder (102) to perform steps to make an edited version of the digital video recorded on the digital video tape (116) ready to be played to the display (120). When the user operates the “Render” control, typically by pressing a button on the case of the camcorder, then the camcorder is programmed to rewind, scan through the digital video tape for include segments, and store in non-volatile, non-sequential computer memory an initial portion for each include segment.

The user presses the “Play Edited Version” control (616) of FIG. 1 to instruct the digital video camcorder (102) to play an edited version of a digital video recorded on the digital video tape (116). An edited version of the digital video tape comprises the raw digital video tape, the time codes identifying the beginning and end of the included segments, and the initial portions of the included segments.

An edited version of the digital video tape (116) is played to the display (120) by playing, for each included segment, an initial portion of the included segment from non-volatile, non-sequential computer memory while fast forwarding to the beginning of the included segment on the raw digital video tape, synchronizing playback from the included segment on the raw digital video tape, and switching playback from the computer memory to the raw digital video tape. In this way, an edited version of the video tape is created without altering the raw digital video tape. By storing multiple sets of times codes and initial portions in non-volatile, non-sequential computer memory, many edited versions of the same raw digital video tape can be made without altering the raw digital video tape and without copying the raw digital video tape.

The digital video camcorder (102) of FIG. 1 includes a user data input interface (620). The user data input interface (620) is shown as a generalized interface. The user uses the user data input interface (620) to input information to the digital video camcorder (102), such as, for example, a date or a tape number. In alternate embodiments, the interface (620) is a keypad, menu driven interface, stylus-touch pad interface, function-key interface, or any other interface that will occur to those of skill in the art.

The digital video camcorder of FIG. 1 includes a display (120). In typical embodiments, the display (120) is a liquid crystal display (LCD) integral to the digital video camcorder (102). The user views the display (120) to see the digital video being recorded on the digital video tape (116) and to see the playback of a digital video recorded on the digital video tape (116). Alternatively, the display (120) is an auxiliary display such as computer monitor, a film editing monitor, television, or any other display that will occur to those of ordinary skill in the art.

The digital video camcorder (102) of FIG. 1 includes a frame counter display (254). The frame counter display (254) is located on the display (120). The frame counter display (254) displays the current frame count of a digital video recorded on the digital video tape (120). The frame count is tracked by a frame counter within the digital video camcorder (102). In typical embodiments, the frame counter display (254) is integral to the display (120). That is, in this example, the frame count is displayed on the display (120) itself rather than on a physically separate display (120). The digital video camcorder (102) of FIG. 1 includes a time display (256). The time display (256) displays the time output of an internal programmable clock within the digital video camcorder (102). In typical embodiments, the time display (256) is integral to the display (120). That is, the time is displayed on the display (120) itself rather that in a physically separate display.

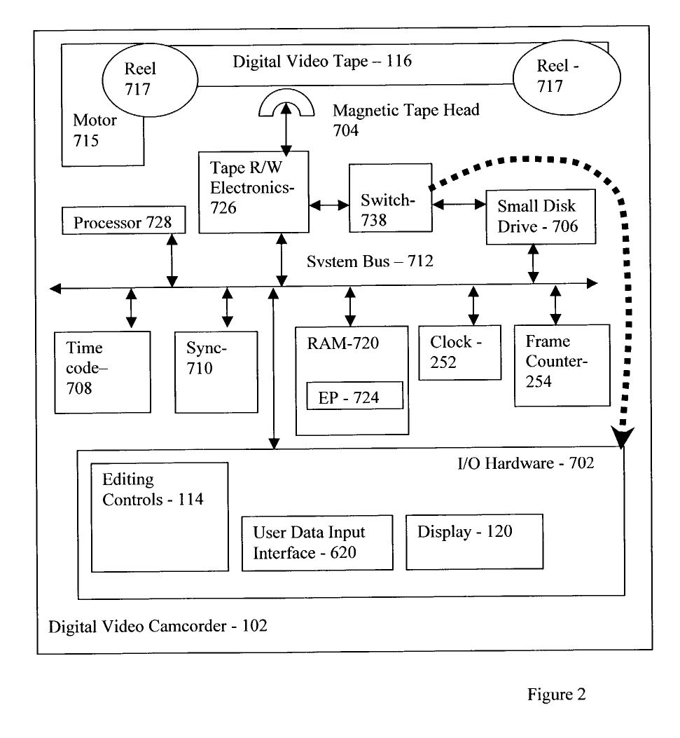

FIG. 2 is a block diagram of an exemplary digital video camcorder (102) according to the present invention. The digital video camcorder (102) of FIG. 2 has at least one processor (728) and random access memory RAM (720). An editing program (724) implementing the steps of the method of the present invention is stored in RAM (720). More particularly, in typical digital video camcorders according to embodiments of the present invention, software routines implementing steps of the invention are prepared and installed as a part of the overall operating software for the digital video camcorder (102). For clarity of explanation, in this application the aggregation of these routines are referred to as the “editing program” (724).

The digital video camcorder (102) of FIG. 2 includes a small disk drive (706) implementing a form of non-volatile, non-sequential computer memory. Examples of small disk drives useful in various forms of the present invention to implement non-volatile, non-sequential computer memory are the Microdrive™ series of small disk drives from International Business Machines Corporation. The Microdrives are presently available in capacities ranging from 170 MB up to 1 GB. The small disk drive (706) stores time codes, initial portions of included segments, and other data as needed. The editing program (724) uses the information and initial portions stored on the small disk drive to implement the steps of the present invention. The small disk drive (706) implements non-volatile, non-sequential computer memory so that the editing program (724) can access the information stored on the small disk drive (706) quickly.

In this disclosure, the term “small disk drive” refers to non-sequential, non-volatile computer memory. “Small disk drive” includes not only drives that comprise magnetic media, like IBM's Microdrives™, but also electronic or solid-state non-sequential, non-volatile computer memory that emulates drives, such as, for example, so called ‘compact flash’ memory cards, ‘memory sticks,’ ‘smartmedia,’ or ‘digital film’ manufactured by, for example, SanDisk Corporation or Lexar Media, Inc. The ‘small’ in “small disk drive” refers to the form factor, devices small enough to be sensible as components in hand-held digital video camcorders, for example. The ‘small’ does not refer to memory capacity. In fact, many non-volatile memory devices useful in various embodiments of the present invention have large memory capacities.

The forms of electronic or solid state memory useful with embodiments of the present invention typically comprise so called ‘flash memory.’ Flash memory is a non-volatile memory device that retains its data when power is removed. Such devices are usually implemented with ‘EEPROM,’ electrically erasable programmable read-only memory. Such devices are similar to EPROM with the exception that they can be electrically erased, whereas typical EPROM must be exposed to ultra-violet light to erase. Flash memory does not need a constant power supply to retain its data and it offers fast access times and low power consumption. These qualities combined with its compact size, make it useful for portable devices like scanners, digital camcorders, cell phones, pagers, hand-helds and printers.

The digital video camcorder (102) of FIG. 2 includes a magnetic tape head (704) and tape read/write electronics (726). The tape read/write electronics (726) reads the digital video from the digital video tape (116) with the magnetic tape head (704) during playback of a digital video. The tape read/write electronics (726) also writes digital video to the digital video tape (116) with the magnetic tape head (704) during the recording of a digital video. The tape read/write electronics (726) also, in some circumstances, writes frame count, time, and other information to the digital video tape (116) with the magnetic tape head (704).

The digital video camcorder (102) of FIG. 2 includes a playback switch (738). The playback switch (738) switches playback between the digital video tape (116) and the small disk drive (706). The digital video camcorder (102) of FIG. 2 includes a clock (252) and a frame counter (254). The clock (252) is programmable, so that a user can set the time. In some circumstances, the ability to set the time can be used to number and thereby identify digital video tapes by, for example, using the hour units and tens as a tape number. The frame counter (254) counts the frames of the digital video recorded on the digital video tape (116).

The digital video camcorder (102) of FIG. 2 includes a time code generator/reader (708). The time code generator/reader reads the time from the clock (252) and the frame count (254) from the frame counter (254) and generates a time code. The tape read/write electronics writes the time code to the digital video tape. The time code generator/reader (708) also reads a time code from the digital video tape (116) with the tape head read/write electronics (726) and the magnetic tape head (704). Examples of time code reader/generators useful with digital video camcorders according to various embodiments of the present invention are model number ICS2008B from Integrated Circuit Systems, Inc., the Eureka integrated circuit, available from Hinton Industries, and model number VITCR/VITCG from Alperman-Velte.

The digital video camcorder (102) of FIG. 2 includes a synchronizer (710). The synchronizer (710) synchronizes the frame and playback speed of a digital video playing from the digital video tape (116) to the display with a digital video playing from the small disk drive (706). The synchronizer (710) synchronizes the digital video playing from the digital video tape (116) and the digital video playing from the small disk drive (706) using the time codes read by the time code generator/reader (708). In some embodiments, the synchronizer is a customized integrated circuit or set of integrated circuits designed and manufactured to fit the form factor of a particular embodiment of a camcorder according to the present invention. In other embodiments, the synchronizer is implemented primarily in software as part of the editing program (724).

The digital video camcorder (102) of FIG. 2 includes a motor (715). The motor (715) moves the reels (717) connected to either end of the digital video tape (116). The motor (715) is rotatably coupled to the reels through capstans (not shown).

FIG. 2 illustrates the motor (715) as connected to only one reel (717). In actual operation, the motor (715) moves both reels (717) by turning capstans in both directions alternately as needed to move the tape forward or backward. The motor (715) turns the capstans in one direction to rewind the digital video tape (116), and turns the capstans in the other direction to play and fast-forward the digital video tape (116). The motor (715) is capable of turning the capstans at multiple speeds.

The digital video camcorder (102) of FIG. 2 has input/output hardware (702). The input/output hardware (702) provides video received from either the tape read/write electronics (726) or the small disk drive (706) to the display. The input/output hardware (702) accepts instructions from the user controlled editing controls (114) and provides the instructions to the editing program (724) through the system bus (712). The input/output hardware also accepts user input data from the user data input interface (620) and provides the user input data to the editing program through the system bus (712).

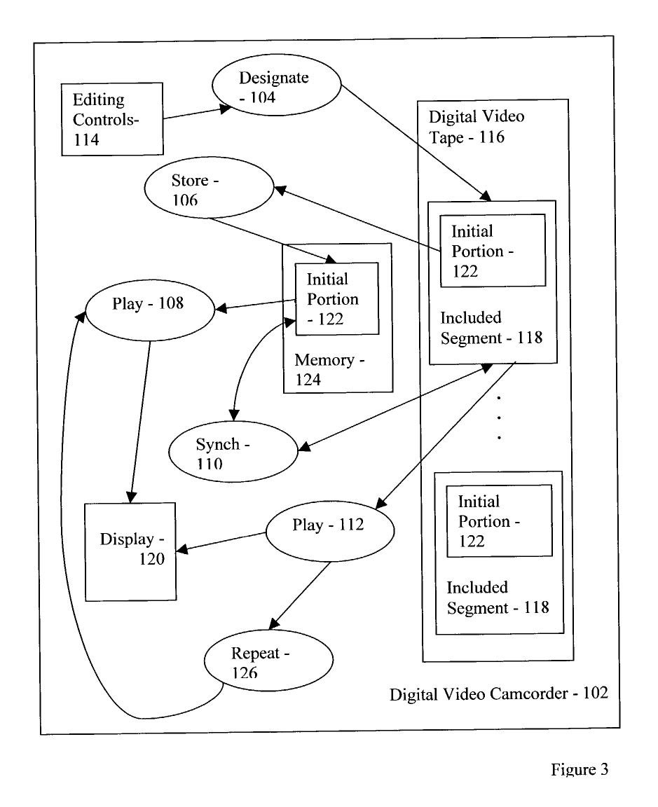

FIG. 3 is a data flow diagram illustrating a method of playing an edited version of a digital video tape with a digital video camcorder (102). The method of FIG. 3 comprises designating (104), through editing controls (114) on a digital video camcorder (102), at least one included segment (118) of the digital video tape (116). The included segment (118) is a subset of the digital video tape (116). The included segment (118) contains digital video recorded on the digital video tape (116) that the user wishes to be played in the edited version of the digital video tape (116). The editing controls (114) through which the user will designate (104) an included segment (118) of the digital video tape (116) are the “In” control (608) and the “Out” control (610) of FIG. 1. In operation, a user designates (104) the beginning of an included segment (118) by pressing the “In” control (reference 608 on FIG. 1) when the user views the beginning of the included segment the user wishes to designate.

Designating (104) an included segment in camcorders according to typical embodiments of the present invention includes the time code generator/reader's (708) reading a time code from the digital video tape (116) corresponding to the frame count of the frame counter (254 on FIG. 2) when a user presses an “In” control. To read the time code on the digital video tape (116), the time code generator/reader (708) instructs the tape read/write electronics (726) to read a time code from the digital video tape (116) with the magnetic tape head (704). Designating (104) an included segment includes in many embodiments storing the time code of the last frame of the included segment as the beginning time code of the included segment in the small disk drive (706).

The user identifies the end of an included segment (118) by pressing the “Out” control (610 on FIG. 1) when the user views the last frame of the included segment the user wishes to designate. Designating (104) an included segment includes detecting the user's pressing the “Out” control and instructing the time code generator/reader (708) to read a time code from the digital video tape (116) that identifies the frame where the user pressed the “Out” control (610). Designating (104) an included segment includes storing the time code of the frame so read on the small disk drive.

In some embodiments, a digital video camcorder (102) includes functions to play digital video from digital video tape (116) to a display in slow motion. In further embodiments, a digital video camcorder (102) includes functions to play the digital video in slow motion frame-by-frame. To accurately designate an included segment, users of camcorders according to such embodiments can view playback of digital video from a digital video tape (116) in frame-by-frame slow motion and press the “In” control when the first frame of the included segment is viewed to designate that frame as the beginning of the included segment and press the “Out” control when the last frame of the included segment is viewed to designate the end of the included segment.

The method of FIG. 3 includes storing (106) in memory (124) an initial portion (122) of the included segment (118). The memory is typically random access memory, a small disk drive, or some other kind of computer memory. Initial portions of included segments stored in the memory need to be accessible for playback fast enough to give the motor and the synchronizer time to synchronize playback from the digital video tape. The memory therefore is advantageously non-sequential, so that access can be had directly to a particular part of the memory with no need to play or scan through or past other parts first. In addition, it is useful for the contents of the memory to survive removal of electrical power from the camcorder, so that edited versions of the digital video tape (comprising both the raw video tape as well as the time codes and initial portions stored in memory) can be retained while the camcorder is turned on and off. The memory therefore is advantageously non-volatile. The memory (124) therefore in many embodiments comprises non-volatile, non-sequential computer memory (124) installed within the digital video camcorder (102). The initial portion (122) of the included segment (118) is a subset of the included segment (118) which is copied into the non-volatile, non-sequential computer memory (124) for quick access.

The method of FIG. 3 includes playing (108) the initial portion (122) from the non-volatile, non-sequential computer memory (124) to a display (120). The digital video camcorder (102) plays (108) the initial portions (122) of the included segments (118) from memory (124) because it can access these initial portions (122) from memory (124) very quickly. More particularly, the digital video camcorder (102) can access the stored initial portion (122) of the included segment (118) from non-volatile, non-sequential computer memory faster than the digital camcorder (102) can rewind or fast-forward the digital video tape (116) to the beginning of included segment (118) and begin playing the digital video recorded on the digital video tape (116) to the display (120).

The method of FIG. 3 includes synchronizing (110) the initial portion (122) playing (108) from non-volatile, non-sequential computer memory (124) and the included segment (118) recorded on the digital video tape (116). The initial portion (122) is playing to the display (120) while the digital video camcorder (102) is synchronizing the initial portion (122) with the included segment (118) on the digital video tape (116).

The method of FIG. 3 includes playing (112) the included segment (118) to the display (120) from the digital video tape (116). The digital video camcorder (102) switches playback from non-volatile, non-sequential computer memory (124) when the initial portion (122) stored in the non-volatile, non-sequential computer memory (1240 is approximately synchronized in frame and playback speed with the included segment (118) recorded on the digital video tape (116). Because the initial portion (122) playing to the display from non-volatile, non-sequential computer memory (124) is approximately synchronized (110) in frame and playback speed with the playback from the digital video tape when playback is switched from memory to the digital video tape (116), the viewer sees only a continuous playback of the included segment played (118) to the display (120).

Synchronization (110) needs to be only approximate because the digital video camcorder (102) plays more frames per second than the average human eye can distinguish. For example, in playback of NTSC video, a digital video camcorder (102) typically plays 30 frames per second. This means that the user views a single frame for only 33 milliseconds. The human eye cannot differentiate one frame from another at a playback speed of 30 frames per second. A digital video becomes fluid to the average human viewer at about 18 frames per second. So long as the speeds of the playback from the digital video tape and from memory are the same and the two sources of playback are within a few frames of one another when playback is switched, the user will continue to perceive a smooth flow of video.

The method of FIG. 3 also includes repeating (126) for a multiplicity of included segments (118) the steps of playing (108) the initial portion (122) from the memory (124) to a display (120), synchronizing (110) the initial portion (122) and the included segment (118), and playing (112) the included segment (118) to the display (120) from the digital video tape. To play the edited version of the digital video tape (116) to the display (102), the digital video camcorder (102) quickly finds and plays the initial portion (122) of the first included segment (118) from non-volatile, non-sequential computer memory (124) to the display. During the playback of the initial portion (122) from non-volatile, non-sequential computer memory(124), the digital video camcorder (102) synchronizes the included segment (118) recorded on the digital video tape (116) by fast-forwarding or rewinding to the beginning of the included segment (118) on the digital video tape (116) and then fast-forwards to catch up to the frame being played to the display (120) from non-volatile, non-sequential computer memory (124). The digital video camcorder (102) synchronizes the included segment (118) in frame and playback speed with the initial portion (122) playing from non-volatile, non-sequential computer memory (124). When the included segment is approximately synchronized with the initial portion playing from non-volatile, non-sequential computer memory (124), the digital video camcorder plays the remainder of the included segment (124) to the display (120) from the digital video tape (116).

At the end of the included segment (118), the method according to FIG. 3 repeats (126). The digital video camcorder (102) accesses the non-volatile, non-sequential computer memory (124) during playback of the remainder of the first included segment and, when playback of the first included segment is completed, plays an initial portion (122) of a second included segment (118a) from non-volatile, non-sequential computer memory (124). While the digital video camcorder (102) is playing (108) the second initial portion (122a) of the second included segment from non-volatile, non-sequential computer memory (124), the digital video camcorder (102) approximately synchronizes (110) the second included segment (118a) recorded on the digital video tape (116) with the second initial portion (122a) of the second included segment (118a) playing (108) to the display (120) from non-volatile, non-sequential computer memory (124). When the digital video camcorder (102) has approximately synchronized (110) the second included segment (118a) playing from the digital video tape (116) with the second initial portion (122a) playing (108) from non-volatile, non-sequential computer memory (124), the digital video camcorder (102) plays (112) the remainder of the second included segment (118a) from the digital video tape (116) to the display (120).

So alternating playback between non-volatile, non-sequential computer memory (124) and the digital video tape (116) presents the viewer with a continuous edited version of the digital video tape (116). Advantageously, rather than having to be disturbed by the time it would otherwise take for the digital video camcorder (102) to rewind or fast forward the digital video tape (116) to the beginning of a next included segment, the viewer sees a continuous edited version of the designated included segments of the digital video tape (116).

The method of FIG. 3 does not alter the original, raw digital video tape (116). Instead, the method described above plays an edited version of a digital video tape to the display by use of time codes and initial portions stored in computer memory. Just as the edited version can be directed to a display, therefore, edited versions maybe recorded onto another digital video tape, compact disc, disc, hard drive or any other medium to make a copy of an edited version of the original digital video tape.

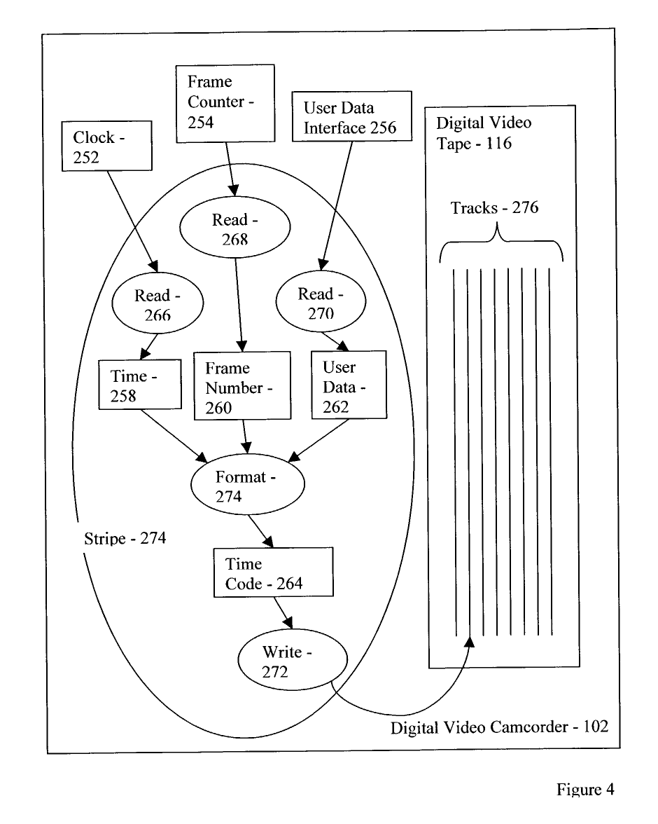

FIG. 4 sets forth a data flow diagram illustrating a method of striping a digital video tape. Striping (274) comprises writing (272) to each frame of the digital video tape (116) a time code. In typical embodiments, the digital video tape (116) is striped with a SMPTE time code. SMPTE time code is a time code promulgated by the Society of Motion Picture and Television Engineers. The SMPTE time code includes a time code representing hours, minutes, seconds, frames, and some additional user data such as tape number and date. For instance, the time code number 01:12:59:16 represents a frame 1 hour, 12 minutes, 59 seconds, and 16 frames into the digital video recording. There are various ways to record time code. Longitudinal time code (LTC) is recorded along the length of the digital video tape (116) in the form of a modulated audio signal. The signal is often recorded on a spare audio channel or, in alternate embodiments, on an “address track” available time code striping. Vertical interval time code (VITC) is recorded in the video signal in an unused area above the active picture, just below vertical sync. VITC does not use an audio track. Alternately, time codes such as MIDI time codes, which are generally considered to be the MIDI readable equivalent to SMPTE, or any other time codes are used. MIDI is a standard interface adopted by the electronic music industry for controlling devices that emit music.

Again referring to FIG. 4, the digital video camcorder (102) is shown to include a clock (252), a frame counter (254), and a user data input interface (256) to enter user data input (256). In the method according to FIG. 4, striping (274) includes reading (266) a time (258) from the clock (252). Striping also includes reading (268) a frame number (260) from the frame counter (254). Striping (274) includes reading (270) user data (256) from the user data input interface (256). Striping(274) includes formatting (274) the time (258), frame number (260), and user data (262) to form a time code (264). In embodiments utilizing SMPTE time codes, formatting the time, frame number, and user data into a time code includes formatting the time, frame number, and user data into a SMPTE time code data structure. Striping includes writing (272) the time code (264) to one of the tracks (276) of the digital video tape (116).

In some embodiments, the digital video tape (116) is striped (274) simultaneously with recording a digital video on the digital video tape. In other embodiments, the digital video camcorder (102) stripes (274) the digital video tape (116) after recording the digital video tape (116). In alternate embodiments, the digital video tape (116) is striped outside of the digital video camcorder (102) using computers, video editing machines, or special purpose hardware.

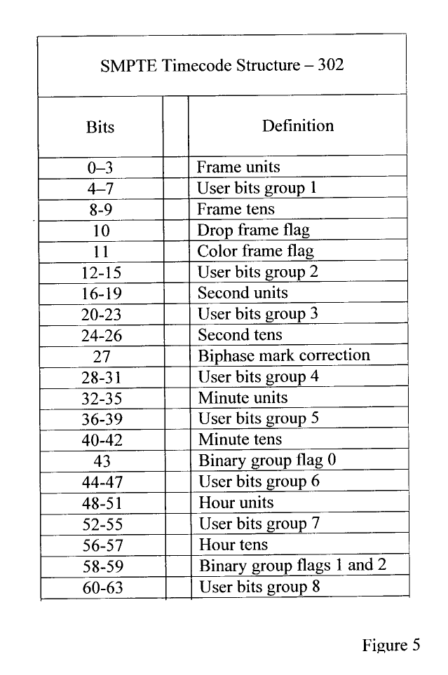

FIG. 5 illustrates an example of a data structure of a SMPTE time code. SMPTE time code is an 80-bit time code. The frame units are stored in bits 0-3, and the frame tens are stored in bits 8-9 of the SMPTE time code. The seconds units are stored in bits 16-19, and the second tens are stored in bits 24-26 of the SMPTE time code. The minutes units are stored in bits 32-35, and the minutes tens are stored in bits 40-42.

The hours units are stored in bits 48-51, and the hours tens are stored in bits 56-57 of the SMPTE time code. The hours, minutes, seconds, and frames are formatted to form the frame counting portion of the time code.

The SMPTE time code of FIG. 5 optionally is “drop-frame” or not “drop-frame” depending on whether bit 10 is set to true. Various digital recording systems exist for recording digital video at frame rates such as 24, 25, 29.97, or 30 frames per second. Time code readers reading drop-frame time codes keep real time by compensating for the difference in systems using different frame rates. When a time code reader reads a digital video tape striped with a drop frame time code, the reader will omit counting frames to keep playback in real time. By way of a more particular example, the National Television Standards Committee (NTSC) has adopted a standard playback speed that is generally considered 30 frames per second. Actually, the NTSC standard is 29.97 frames per second. When a time code reader counts the time codes on a digital video tape recorded with the NTSC standard and striped with a drop-frame time code, the time code counter excludes 3 frames every 3000 seconds. By not counting the frames, the time code reader counts the digital video in the real time in which it was recorded. When a time code reader reads the time codes of a digital video striped with a non-drop frame time code, the time code reader counts each and every frame. The actual play-time digital video striped with a non-drop frame time code will be shorter than the playtime the time code reader reads.

The color frame flag is stored on bit 11 of the SMPTE time code of FIG. 5. The color frame flag indicates whether the time code carries a standard sequence of color information for use in color synchronization in video playback.

User bits group 1 are stored on bits 4-7 of the SMPTE time code of FIG. 5. User bits group 2 are stored in bits 12-15, user bits group 3 are stored in bits 20-23, user bits group 4 are stored in bits 28-31, user bits group 5 are stored in bits 36-39, user bits group 6 are stored in bits 44-47, user bits group 7 are stored in bits 52-55, and user bits group 8 is stored in bits 60-63 of the SMPTE time code of FIG. 5. The user bits are designated for user specified input such as tape number and date. For a digital video camcorder to stripe a digital video tape with user data in the user bits, the digital video camcorder must have an interface to allow the user to input this user data. If the digital video camcorder does not have an interface allowing the user to input user data to be striped into the time code, the digital video camcorder has a programmable clock, the hour of the clock maybe set to a number to be the tape number. Setting the hour as the tape number stores this tape number information in bits 48-51 and 56-57 of the SMPTE time code of FIG. 5.

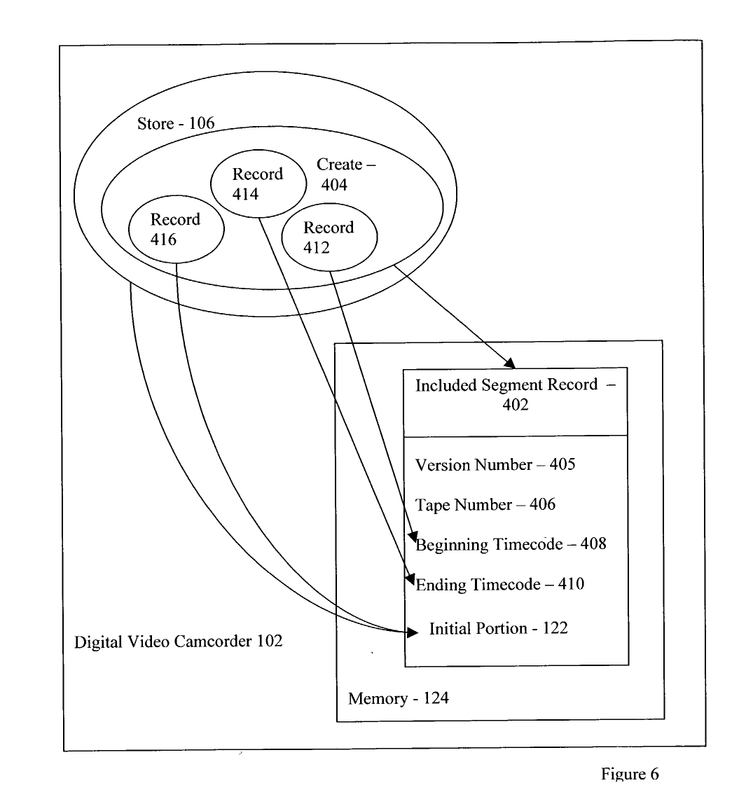

Binary group flag 0 is stored in bit 43, and binary group flags 1 and 2 are stored in bits 58-59 of the SMPTE time code of FIG. 5. The binary group flags are used to indicate whether a standard character set is used to format the user bits stored in bits 4-7; 12-15; 20-23; 28-31; 36-39; 44-47; 52-55; and 60-63. The biphase mark correction is stored in bit 27 of the SMPTE time code of FIG. 5. Bi-phase encoding reverses the signal polarity half-way through the bit to represent a “1” and leaves the bit polarity unchanged to represent a “0.” The biphase mark is designed to regulate the phase of the pulse train of the 80-bit SMPTE time code. A sync word is stored in bits 64-79 of the SMPTE time code of FIG. 6. A time code reader reads information such as tape direction, playback speed, and frame boundaries from the sync word.

FIG. 6 is a data flow diagram illustrating a method of storing (106) an initial portion (122) of an included segment (402) in memory (124). An initial portion (122) is a copy of the beginning of the included segment that is sufficiently long that when played to the display of the digital video camcorder, the digital video camcorder (102) has time to synchronize the initial portion (122) and the included segment in frame and playback speed and switch from playback from non-volatile, non-sequential computer memory to playback the included segment from the digital video tape (116). The initial portion (122) in many embodiments is stored in non-volatile, non-sequential computer memory so that the digital video camcorder can access and begin playing the initial portion (122) quickly.

In the method of FIG. 6, storing (106) an initial portion in non-volatile, non-sequential computer memory (124) includes creating (404) an included segment record (402) in non-volatile, non-sequential computer memory (124). The included segment record (402) can be a database record or a record in a file stored in non-volatile, non-sequential computer memory (124). The method of FIG. 6 includes recording (416) the initial portion (122) in the included segment record (402) created in non-volatile, non-sequential computer memory (124). Alternatively, the digital video camcorder (102) creates a file having a filename in non-volatile, non-sequential computer memory and stores the initial portion (122) in the file. In such an embodiment, a digital video camcorder (102) then stores the filename in an initial portion filename field (123) in an included segment record (402).

The method of FIG. 6 also includes recording (412) a beginning time code (408) in the included segment record (402) created in the non-volatile, non-sequential computer memory (124). The method includes recording (414) an ending time code (410) in the included segment record (402). The digital video camcorder (102) accesses the beginning time code (408) and the ending time code (410) from the included segment record to identify the beginning and the end of included segments during playback.

Some camcorders according to embodiments of the present invention include a version identification code, such as, for example, the version number (405) in the included segment records (402) on FIG. 6. Such camcorders support creating multiple edited versions of the same raw digital video tape by recording a separate version identification code in each included segment record of each separate version. Methods of operation of such camcorders include prompting a user for a version identification code the first time the user operates the “In” control. The user enters the version identification code through the user input data interface (620 on FIG. 1). Methods of playing edited versions on such camcorders include prompting a user for a version identification code when the user operates the “Play edited version” control (616 on FIG. 1), the user's entering a version identification code through the user input data interface (620 on FIG. 1), and playing to a display (120 on FIG. 1) included segments identified by the entered version identification code.

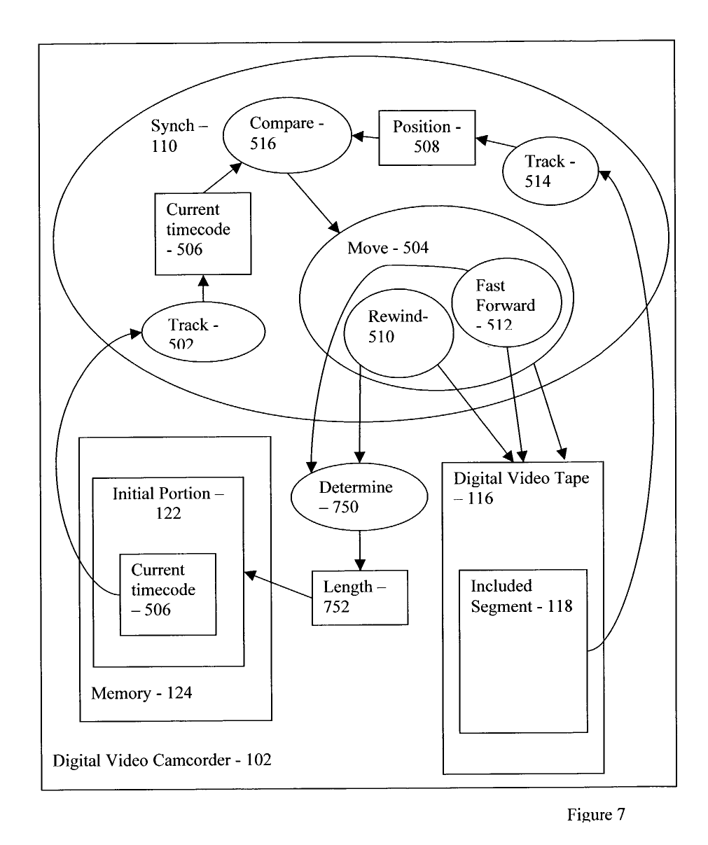

FIG. 7 is a data flow diagram depicting a method of synchronizing (110) playback between an initial portion (122) from non-volatile, non-sequential computer memory (124) and digital video tape (116). In the method of FIG. 7, synchronizing (110) an initial portion (122) playing from non-volatile, non-sequential computer memory (124) with playback of an included segment from a digital video tape (166) includes tracking (502) a current time code (506) of the initial portion (122) playing from non-volatile, non-sequential computer memory (124). Each frame of a striped digital video has a time code assigned to it.

In the method according to FIG. 7, synchronizing (110) an initial portion (122) playing from non-volatile, non-sequential computer memory (124) and a digital video tape (116) includes moving (504) the digital video tape (116) to a position (508) having approximately the tracked current time code (506). Moving (504) the digital video tape (116) to a position (508) that has approximately the tracked current time code (506) comprises rewinding (510) or fast-forwarding (512) the digital video tape such to a frame of the digital video tape (116) having approximately the same time code as the tracked time code (506) of the initial portion (122).

In the method according to FIG. 7, synchronizing (110) the initial portion (122) playing from non-volatile, non-sequential computer memory (124) with the digital video tape (116) also includes comparing (516) the tracked current time code (506) of the initial portion (122) with the included segment (118) recorded on the digital video tape (116).

The method according to FIG. 7 includes moving (504) the included segment (118) to the current time code. Moving (504) includes rewinding (510) or fast-forwarding (512) the digital video tape (116) until the current time code of the included segment (118) matches the current time code (506) of the initial portion (122) playing from non-volatile, non-sequential computer memory. Synchronizing (701) includes matching the playback speed of the digital video tape (116) with the playback speed of the initial portion being played from the small disk drive.

The method according to FIG. 7 includes determining (750) the length (752) of the initial portion (122). The length (752) of the initial portion (122) stored in non-volatile, non-sequential computer memory (124) is sufficiently long to give the digital video camcorder (102) time to fast-forward (512) or rewind (510) to the next included segment on the digital video tape (116) and synchronize (110) the next included segment (118) recorded on the digital video tape (116) with the next initial portion (122) playing from non-volatile, non-sequential computer memory (124) in frame and playback speed. The farther away the two included segments are located, the longer the initial portion (122) must be so that the initial portion (122) is long enough to give the digital video camcorder (102) time to synchronize (110) and switch playback from the non-volatile, non-sequential computer memory (124) to the digital video tape (116). Determining (750) the length of the initial portion (122) is dependant upon the speed at which the camcorder can rewind or fast-forward the digital video tape (116) to a next included segment (118), synchronize (110) playback from the next included segment on digital tape and the corresponding initial portion (122) from non-volatile, non-sequential computer memory (124) in frame and playback speed and switch to playing from the digital video tape.

In some embodiments, determining (750) the length of the initial portion is dependent upon the following approximate formula:

Iₙ=[(|(TC_{beg}−TC_{end})|/FF]+([((TC_{beg}−TC_{end})/FF(P/FF)),

where

Iₙ=length of the initial portion in seconds,

FF=fast-forward speed in frames per second,

P=play speed in frames per second,

TC_{beg}=time code of the beginning of the second included segment, and

TC_{end}=time code of the ending of the first included segment.

The equation above provides an approximate calculation. (TC_{beg}−TC_{end}) is the number of frames that the beginning of a second included segment is separated from the end of a first included segment. In this formula, a second included segment is after a first included segment on the digital video tape. If a second included segment is before a first included segment on the digital video tape, then the distance value results in a negative number. Therefore, the equation uses absolute value of the distance between included segments.

The equation divides the distance between the end of the first included segment and the beginning of the second included segment by the fast-forward speed (FF) in frames per second. The result of the division is the time it takes to fast-forward the digital video tape from the end of the first included segment to the beginning of the second included segment. If the second included segment is before the first included segment, the fast-forward speed is replaced with the rewind speed.

The next term of the equation, ([((TC_{beg}−TC_{end})/FF(P/FF)), represents the time it takes the digital video camcorder to fast-forward to the frame of the initial portion playing from non-volatile, non-sequential computer memory. This term is a fraction of the time it took the digital video camcorder to fast-forward from the end of the first included segment to the beginning of the next included segment. (P/FF) is the ratio of playback speed and fast-forward speed.

Using a formula similar to the one above, the digital video camcorder stores in non-volatile, non-sequential computer memory (124) an initial portion of the included segment that is long enough to support synchronization. To conserve resources, the digital video camcorder does not store unneeded frames of initial portion.

Use Case

As a further aid to understanding, an example use case is presented. With reference to FIGS. 1 and 2: A user begins by viewing playback of a raw unedited digital video tape (116) on a display (120) on a digital video camcorder (102). When the user sees the beginning of an included segment, the user presses the “In” control (608). The editing program (724) detects the user pressing the “In” control (608) through the I/O hardware (702) and designates an included segment. The editing program (724) creates an included record segment in non-volatile, non-sequential computer memory on the small disk drive (706). The editing program (724) instructs the time code generator/reader (708) to read the time code on the digital video tape (116). The time code generator/reader reads a time code through the tape read/write electronics (726) and the magnetic tape head (704), and returns the time code to the editing program (724). The editing program (724) then records the time code as the beginning time code in the included segment record in non-volatile, non-sequential computer memory on the small disk drive (706).

When the user views the end of the included segment (118), the user presses the “Out” control (610). The editing program (724) detects the user's pressing the “Out” control (610) and continues the process of designating an included segment. The editing program (724) instructs the time code generator/reader (708) to read the time code from the digital video tape (116). The time code generator/reader (708) reads the time code from the digital video tape through the tape read/write electronics (726) and the magnetic tape head (704) and returns the time code to the editing program (724). The editing program (724) records the time code in the included segment record stored in non-volatile, non-sequential computer memory on the small disk drive (706) as an ending time code.

The user may now designate another included segment. The user continues to view the playback of the digital video tape on the display and again presses the “In” control (608). The editing program (724) detects the user's pressing the “In” control (608) and creates the second included segment record in non-volatile, non-sequential computer memory (724) on the small disk drive (706). The editing program (724) instructs the time code generator/reader (708) to read and return the time code from the digital video tape (116) and the editing program (724) records the time code as the second beginning time code in the second included segment record.

When the user views the final frame of the second included segment, the user presses the “Out” control (610). The editing program (724) detects the user's pressing the “Out” control (610) and instructs the time code generator/reader (708) to read and return the time code from the digital video tape (116). The editing program (724) records the time code as the second ending time code in the second included record segment.

The user continues to designate included segments by alternately pressing the “In” control (608) and “Out” control (610). There is no limitation that the user must continue sequentially through the tape from beginning to end. The user is free to rewind the tape between designations of included segments so that the included segments are designated in an order different from the order in which they were recorded on the raw digital video tape. Digital video camcorders according to embodiments of the present invention typically play included segments in edited versions of the digital video tape in the order in which they are designated, thereby playing the included segments in an order different from the order in which they were recorded on the raw digital video tape.

When the user has designated all of the included segments to be played in the edited version of the digital video tape, the user presses the “Render” control (612). The editing program (724) detects the user's pressing the “Render” control (612) and reads the beginning time code in the first included segment record stored in non-volatile, non-sequential computer memory on the small disk drive (706). The editing program (724) rewinds or fast-forwards the digital video tape (116) to the beginning time code of the first included segment record by instructing the motor (715) to turn capstans inserted into reels (717) connected on either end of the digital video tape (116) and instructing the time code generator/reader (708) to read the time codes on the rewinding or fast-forwarding digital video tape (116). The motor stops rewinding or fast-forwarding the digital video tape when the time code generator/reader (708) reads the beginning time code of the first included record segment.

The editing program (724) copies an initial portion of the included segment into the first included segment record. Alternatively, for embodiments that support recording video in separate files rather than directly into other data structures, the editing program (724) creates a file having a filename, copies an initial portion of the included segment into the file, and records the filename in the first included segment record.

The editing program (724) reads the beginning time code of the second included segment record from the second included segment record in non-volatile, non-sequential computer memory on the small disk drive (706). The editing program (724) instructs the motor (715) to rewind or fast-forward the digital video tape (116) and instructs the time code generator/reader (708) to read the time codes on the rewinding or fast-forwarding digital video tape (116). The motor stops rewinding or fast-forwarding the digital video tape when the time code generator/reader (708) reads the beginning time code of the second included record segment. The editing program (724) copies an initial portion of the second included segment into the second included segment record recorded in non-volatile, non-sequential computer memory on the small disk drive (706).

For each included segment record, the editing program (724) reads the beginning time code of the next included segment record from the next included segment record in non-volatile, non-sequential computer memory on the small disk drive (706). The editing program (724) instructs the motor (715) to rewind or fast-forward the digital video tape (116) and instructs the time code generator/reader (708) to read the time codes on the rewinding or fast-forwarding digital video tape (116). The motor stops rewinding or fast-forwarding the digital video tape when the time code generator/reader (708) reads the beginning time code of the next included record segment. The editing program (724) copies an initial portion of the next included segment into the next included segment record recorded in non-volatile, non-sequential computer memory on the small disk drive (706).

When the user wishes to view an edited version of the digital video tape, the user presses the “Play edited version” control (616). The editing program (724) detects the user's pressing the “Play edited version” control (616) and reads the first included segment record and plays the first initial portion recorded on the small disk drive (706) to the display (120). While the initial portion is playing to the display, the editing program (724) reads the beginning time code from the first included segment record and instructs the motor (715) to rewind or fast forward to the beginning time code.

The time code generator/reader (708) reads and returns to the editing program (724) the time codes from the moving digital video tape through the tape read/write electronics (726) and the magnetic tape head. When the digital video tape (116) has been rewound or fast-forwarded to the beginning time code of the first included segment record, the editing program instructs the synchronizer (710) to synchronize the digital video tape (116) in frame number and play speed with the initial portion playing to the display (120) from the small disk drive (706). The time-code generator/reader tracks the time code of the initial portion playing to the display (120) from the small disk drive (706) and tracks the time code of the rewinding or fast-forwarding digital video tape (116). The time code generator/reader (708) returns the tracked time codes to the synchronizer.

The synchronizer (110) instructs the motor (715) to fast-forward to the frame of the initial portion playing to the display (120) from the small disk drive. When the digital video tape (116) is fast-forwarded to frame of the initial portion playing to the display from the small disk drive, the synchronizer instruct the motor to move the digital video at approximately the playback speed of the initial portion playing to the display from the small disk drive. With the initial portion playing to the display from the small disk drive approximately synchronized in the frame and playback speed the editing program (724) instructs the switch to play the digital video tape to the display (120). The editing program (724) reads the ending time code from the first included segment record and instructs time code generator/reader to track the time code of the digital video tape playing to the display.

When the frame of the ending time code of the first included segment record is played to the display, the editing program reads the beginning time code of the second included record segment recoded in non-volatile, non-sequential computer memory on the small disk drive. The editing program (724) plays the second initial portion recorded on the small disk drive (706) to the display (120). While the second initial portion is playing to the display, the editing program (724) reads the beginning time code from the second included segment record and instructs the motor (715) to rewind or fast forward to the beginning time code.

The time code generator/reader (708) reads and returns to the editing program (724) the time codes from the moving digital video tape through the tape read/write electronics (726) and the magnetic tape head. When the digital video tape (116) has been rewound or fast-forwarded to the beginning time code of the second included segment record, the editing program instructs the synchronizer (710) to synchronize the digital video tape (116) in frame number and play speed with the initial portion playing to the display (120) from the small disk drive (706). The time-code generator/reader tracks the time code of the initial portion playing to the display (120) from the small disk drive (706) and tracks the time code of the rewinding or fast-forwarding digital video tape (116). The time code generator/reader (708) returns the tracked time codes to the synchronizer.

The synchronizer (110) instructs the motor (715) to fast-forward to the frame of the initial portion playing to the display (120) from the small disk drive. When the digital video tape (116) is fast-forwarded to frame of the initial portion playing to the display from the small disk drive, the synchronizer instruct the motor to move the digital video at approximately the playback speed of the initial portion playing to the display from the small disk drive. With the initial portion playing to the display from the small disk drive approximately synchronized in the frame and playback speed the editing program (724) instructs the playback switch to play the digital video tape to the display (120). The editing program (724) reads the ending time code from the second included segment record and instructs time code generator/reader to track the time code of the digital video tape playing to the display. When the frame of the ending time code of the second included segment record is played to the display, the editing program reads the beginning time code of the second included record segment recoded in non-volatile, non-sequential computer memory on the small disk drive.

While the digital video camcorder (102) of FIG. 1 is shown with “In” (608), “Out” (610), “Render” (612), and “Play edited version” (612) controls, in alternate embodiment different controls instruct the application software to perform the method of the present invention. Different software also performs the steps of the method of the invention. For example, the “In” (608) and “Out” (610) could be combined to a single designate control to designate the included segment. The editing program detects the user's pressing the designate control and begins to perform the steps of designating an included segment described above as associated with the “In” control. The next time the user presses the designate control, the editing program performs the steps described above associated with the “Out” control.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for playing an edited version of a digital video tape, the method comprising:
designating, through controls on a digital video camcorder, at least one included segment of the digital video tape;
storing in memory an initial portion of the included segment, wherein the memory comprises non-volatile, non-sequential computer memory installed within a digital video camcorder;
playing the initial portion from the memory to a display;
synchronizing the initial portion and the included segment; and
playing the included segment to the display.

2. The method of claim 1 further comprising repeating for a multiplicity of included segments the steps of:
playing the initial portion from the memory to a display;
synchronizing the initial portion and the included segment; and
playing the included segment to the display.

3. The method of claim 1 further comprising striping the digital video tape.

4. The method of claim 1 wherein storing in memory an initial portion of the included segment comprises creating an included segment record in memory.

5. The method of claim 4 wherein creating an included segment record in memory comprises recording, in an included segment record, a beginning time code for the included segment and recording an ending time code for the included segment.

6. The method of claim 1 wherein storing an initial portion of the included segment comprises recording the initial portion in an included segment record.

7. The method of claim 1, wherein storing an initial portion of the included segment comprises storing the initial portion in memory and storing a filename in an included segment record.

8. The method of claim 1 wherein the initial portion of the included segment is of sufficient length to support synchronizing the initial portion and the included segment.

9. The method of claim 8, further comprising determining the length of the initial portion.

10. The method of claim 1 wherein synchronizing further comprises:
tracking a current time code from the initial portion; and
moving the included segment to the tracked current time code.

11. A digital video camcorder comprising:
means for designating, through controls on a digital video camcorder, at least one included segment of the digital video tape;
means for storing in memory an initial portion of the included segment, wherein the memory comprises non-volatile, non-sequential computer memory installed within a digital video camcorder;
means for playing the initial portion from the memory to a display;
means for synchronizing the initial portion and the included segment; and
means for playing the included segment to the display.

12. The digital video camcorder of claim 11 further comprising means for repeatedly playing the initial portion from the memory to a display, synchronizing the initial portion and the included segment, and playing the included segment to the display.

13. The digital video camcorder of claim 11 further comprising means for striping the digital video tape.

14. The digital video camcorder of claim 11 wherein means for storing in memory an initial portion of the included segment comprises means for creating an included segment record in memory.

15. The digital video camcorder of claim 14 wherein means for creating an included segment record in memory comprises means for recording, in an included segment record, a beginning time code for the included segment and means for recording an ending time code for the included segment.

16. The digital video camcorder of claim 11 wherein means for storing an initial portion of the included segment comprises means for recording the initial portion in an included segment record.

17. The digital video camcorder of claim 11, wherein means for storing an initial portion of the included segment comprises means for storing the initial portion in memory and means for storing a filename in an included segment record.

18. The digital video camcorder of claim 11 wherein the initial portion of the included segment is of sufficient length to support synchronizing the initial portion and the included segment, and the digital video camcorder further comprises means for determining the length of the initial portion.

19. The digital video camcorder of claim 11 wherein means for synchronizing further comprises:
means for tracking a current time code from the initial portion; and
means for moving the included segment to the tracked current time code.

20. An edited version of a digital video tape, made by the steps of:
designating, through controls on a digital video camcorder, at least one included segment of the digital video tape;
storing in memory an initial portion of the included segment, wherein the memory comprises non-volatile, non-sequential computer memory installed within a digital video camcorder;
playing the initial portion from the memory to a display;
synchronizing the initial portion and the included segment; and
playing the included segment to the display.

21. The edited version of the digital video tape of claim 20, made by the further steps of recording the playing the initial portion from the memory to a display, and the playing the included segment to the display.
